(19) United States
(12) Patent Application Publication
(10) Pub. No.: US 2019/0363474 A1
(43) Pub. Date: Nov. 28, 2019

(54) MANUFACTURING METHOD FOR CONNECTER HOUSING

(71) Applicants: Takaji KIKUCHI, Toyota-shi (JP); Shinji AMEMIYA, Hamamatsu-shi (JP)

(72) Inventors: Takaji KIKUCHI, Toyota-shi (JP); Shinji AMEMIYA, Hamamatsu-shi (JP)

(73) Assignees: TOYOTA JIDOSHA KABUSHIKI KAISHA, Toyota-shi (JP); TYCO ELECTRONICS JAPAN G.K., Kawasaki-shi (JP)

(21) Appl. No.: 16/392,992

(22) Filed: Apr. 24, 2019

(30) Foreign Application Priority Data
May 25, 2018 (JP) 2018-100921

(51) Int. Cl. H01R 13/436; H01R 43/18; B29C 45/14

(52) U.S. Cl. CPC H01R 13/436; B29C 45/14008; H01R 43/18

(57) ABSTRACT

A manufacturing method for a connector housing to which an elongated metal terminal is connected may include injecting molten resin into a mold so as to form the connector housing. The mold may include a first projection configured to form an inlet for the metal terminal and a second projection configured to form a terminal connection space communicating with the inlet, the second projection being movable relative to the first projection. A diameter of a tip end of the second projection may be larger than a diameter of a tip end of the first projection and a recess in which the tip end of the first projection is inserted may be provided in an end face of the second projection.

### CROSS-REFERENCE TO RELATED APPLICATION

This application claims priority to Japanese Patent Application No. 2018-100921 filed on May 25, 2018, the contents of which are hereby incorporated by reference into the present application.

### TECHNICAL FIELD

The technique disclosed herein relates to a manufacturing method for a connector housing to which a metal terminal is inserted.

### BACKGROUND

An electric device includes a connector housing into which an elongated metal terminal is inserted (see Japanese Patent Application Publications Nos. 2017-55585, 2013-235772, and H10-81007). The connector housing is constituted of resin in many cases. The connector housing includes an inlet into which the metal terminal is inserted. In the case where the connector housing constituted of resin, burr may be formed inside the inlet (see Japanese Patent Application Publications No. 2013-235772 and H10-81007). If the burr contacts with the metal terminal when the metal terminal is inserted, the metal terminal may be damaged. In a case where the metal terminal is plated, the plating may be peeled off because of its contact with the burr.

### SUMMARY

The disclosure herein discloses a technique that directs a growth direction of burr formed when a connector housing is manufactured to a direction in which the burr less likely damages a metal terminal.

A manufacturing method disclosed herein may comprise injecting molten resin into a mold so as to form the connector housing, wherein the mold comprises: a first projection configured to form an inlet for the metal terminal; and a second projection configured to form a terminal connection space communicating with the inlet, the second projection being movable relative to the first projection, a diameter of a tip end of the second projection is larger than a diameter of a tip end of the first projection, and a recess in which the tip end of the first projection is inserted is provided in an end face of the second projection.

### BRIEF DESCRIPTION OF THE DRAWINGS

FIG. 1 is a cross-sectional view (1) of a power converter including connectors;

FIG. 2 is a cross-sectional view (2) of the power converter including the connectors;

FIG. 3 is a cross-sectional view of a connector housing;

FIG. 4 is an enlarged view of a range IV in FIG. 3;

FIG. 5 is a cross-sectional view (1) of a mold for manufacturing the connector housing;

FIG. 6 is a cross-sectional view (2) of the mold for manufacturing the connector housing;

FIG. 7 is a cross-sectional view (3) of the mold for manufacturing the connector housing; and

FIG. 8 is an enlarged view of a range VIII in FIG. 7.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved manufacturing methods for a connector housing.

Moreover, combinations of features and steps disclosed in the following detailed description may not be necessary to practice the present disclosure in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

One aspect of a manufacturing method for a connector housing may comprise injecting molten resin into a mold so as to form the connector housing. The mold may comprise: a first projection configured to form an inlet for the metal terminal; and a second projection configured to form a terminal connection space communicating with the inlet. The second projection may be movable relative to the first projection. A diameter of an end (tip end) of the second projection may be larger than a diameter of an end (tip end) of the first projection, and a recess in which the tip end of the first projection is inserted may be provided in an end face of the second projection.

When this mold is used, burr is formed between the recess of the second projection and the first projection. The burr grows toward an innermost portion of the recess along a side surface of the first projection. A growth direction of the burr is coincident with an inserting direction of the metal terminal. Therefore, even if the burr remains in the finished connector housing, the burr does not damage the metal terminal because the burr extends along the inserting direction of the metal terminal.

The first projection may taper off to the end thereof. Due to this, the metal terminal can be easily inserted.

### Embodiments

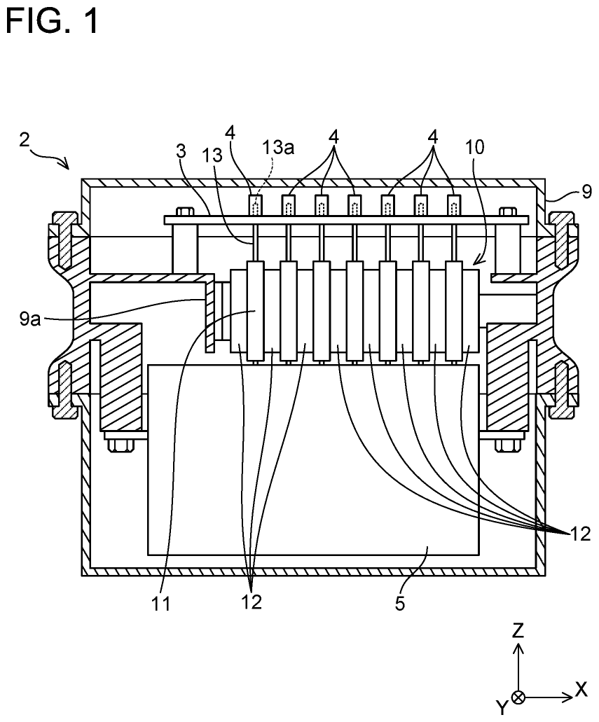

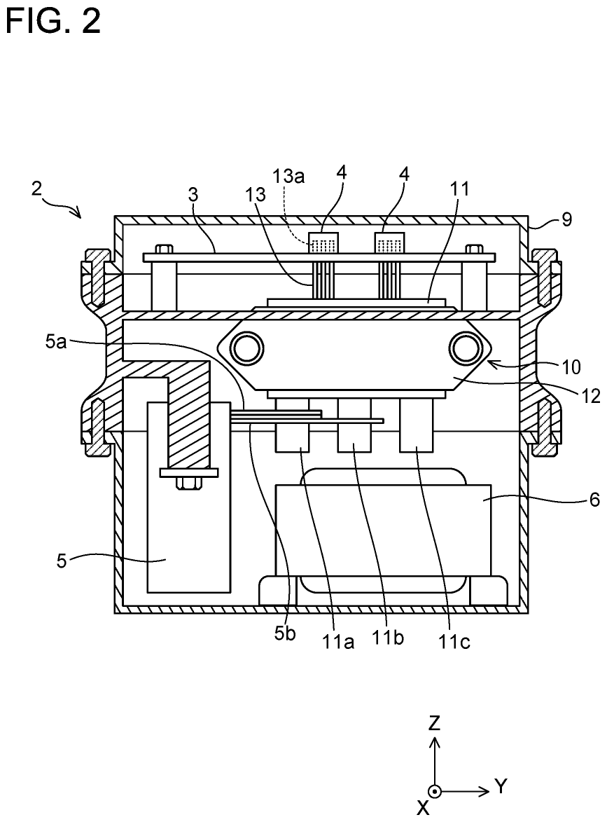

First, a power converter will be described as an example of a device using a connector. FIGS. 1 and 2 are cross-sectional views of a power converter 2. FIG. 1 illustrates a cross section of the power converter 2 with a casing side plate on a −Y side in a coordinate system in FIG. 1 omitted. FIG. 2 illustrates a cross section of the power converter 2 with a casing side plate on a +X side omitted. The power converter 2 is a device that is mounted on an electric vehicle and is configured to convert power of a battery to driving power for a traction motor.

A stacked unit 10, a substrate 3, a capacitor 5, and a reactor 6 are accommodated in a casing 9 of the power converter 2. The stacked unit 10 is a device in which a plurality of semiconductor modules 11 and a plurality of coolers 12 are stacked on one another. Each of the semiconductor modules 11 includes two transistors. In FIG. 1, the reference sign 11 is given only to a leftmost one of the semiconductor modules, and it is omitted for the remaining semiconductor modules. The coolers 12 are arranged in parallel to each other. Each pair of the adjacent coolers 12 interposes one of the semiconductor modules 11 therebetween. The stacked unit 10 is interposed between a sidewall of the casing 9 and an intermediate wall 9a in a direction along which the coolers 12 are arranged.

Three power terminals 11a, 11b, and 11c extend from a lower surface of each semiconductor module 11. The two transistors are connected in series inside each semiconductor module 11, and the power terminals 11a, 11b, and 11c respectively correspond to a positive electrode, a negative electrode, and a mid point of the series connection of the two transistors.

The power terminals 11a are connected to one of electrodes of the capacitor 5 by busbars 5a. The power terminals 11b are connected to another electrode of the capacitor 5 by busbars 5b. A portion to which the power terminals 11c are connected is not illustrated.

A plurality of control terminals 13 extends from an upper surface of each semiconductor module 11. The control terminals 13 include a gate terminal connected to a gate electrode of the transistor, a sensor terminal connected to a temperature sensor that measures an internal temperature of the semiconductor module 11, and the like.

The substrate 3 is disposed above the stacked unit 10. The substrate 3 has a control circuit for controlling the transistors of the semiconductor modules 11 mounted thereon. The substrate 3 is provided with a plurality of connectors 4. The control terminals 13 extending from each semiconductor module 11 penetrate through the substrate 3 and terminal ends 13a are connected to the connectors 4. In FIG. 1, the reference sign 13 is given only to a leftmost one of the control terminals, and it is omitted for the remaining control terminals. Three control terminals 13 are connected to each one of the connectors 4.

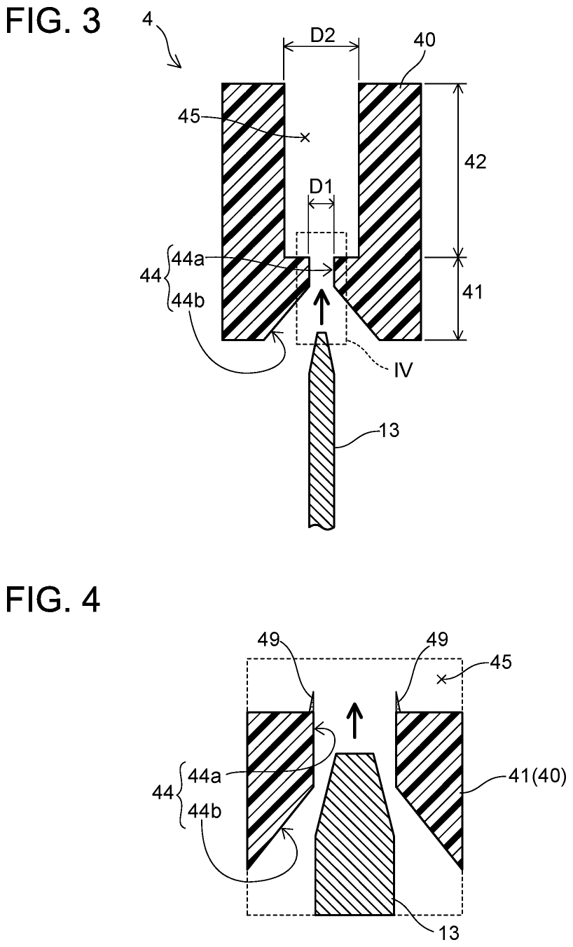

A main body of each connector 4 corresponds to a connector housing 40. The connector housings 40 are constituted of resin. FIG. 3 is a cross-sectional view of the connector housing 40. As described before, each one of the connectors 4 is connected to three control terminals 13, however, FIG. 3 and the subsequent drawings illustrate a connecting portion with one of the control terminals 13. Connecting portions with the remaining two control terminals also have the same structure.

The connector housing 40 is formed by resin injection molding. The connector housing 40 includes a tip end portion 41 provided with an inlet 44 into which the control terminal 13 is to be inserted, and a rear portion 42 provided with a connection space 45 that communicates with an innermost portion of the inlet 44 in an inserting direction of the terminal. Although a connector-side terminal configured to be in contact with the control terminal 13 is disposed in the connection space 45, it is not illustrated.

The inlet 44 includes a parallel hole portion 44a that is closer to the connection space 45 and a tapering portion 44b that is farther from the connection space 45. The tapering portion 44b becomes wider from the parallel hole portion 44a toward outside of the connector housing 40. In other words, the tapering portion 44b tapers off toward the innermost portion of the inlet 44. The tapering portion 44b that becomes wider toward the outside of the connector housing 40 has a function of guiding a tip end of the control terminal 13 when it is inserted.

A diameter D1 of the parallel hole portion 44a of the inlet 44 is approximately the same as a diameter of the control terminal 13. A diameter D2 of the connection space 45 that communicates with the innermost portion of the parallel hole portion 44a is larger than the diameter D1 of the parallel hole portion 44a. In other words, the diameter D2 of the connection space 45 is larger than the diameter D1 of the inlet 44 at its edge closer to the connection space 45.

A boundary between the connection space 45 and the inlet 44 forms a step. Therefore, a parting boundary (parting line) of a mold for forming the connector housing 40 is located near the boundary between the connection space 45 and the inlet 44. Burr may be formed along the parting line. If the burr extends perpendicularly to the inserting direction of the control terminal 13 from an inner surface of the inlet 44, the burr may interfere with the control terminal 13 when the control terminal 13 is inserted. The interference with the burr may damage the control terminal 13. In a case where a surface of the control terminal 13 is plated, the plating may be peeled off because of its contact with the burr. A manufacturing method for a connector housing according to an embodiment disclosed herein can control a growth direction of burr to prevent the control terminal 13 from being damaged by contact with the burr.

FIG. 4 is an enlarged view of a range IV surrounded by a broken line in FIG. 3. As shown in FIG. 4, in the connector housing 40, burr 49 extends from the edge of the inlet 44 closer to the connection space 45 along the inserting direction of the control terminal 13 (a bold arrow in FIG. 4). Thus, the control terminal 13 is less likely to come into contact with the burr 49, so that the control terminal 13 is less likely to be damaged. As described above, the manufacturing method for a connector housing according to the embodiment can control the growth direction of burr to the inserting direction of terminal to prevent the control terminal 13 from being damaged by contact with the burr.

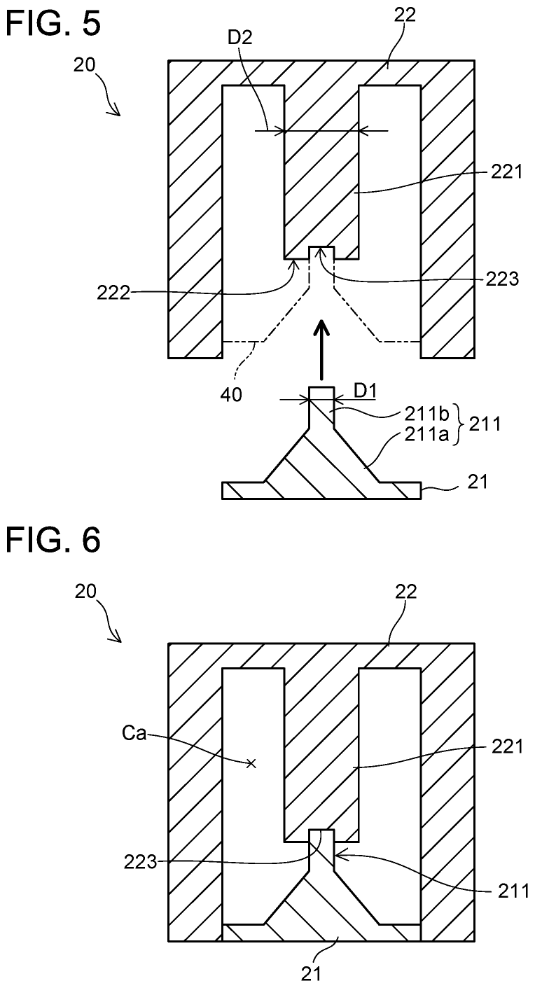

Referring to FIGS. 5 to 8, a manufacturing method for the connector housing 40 will be described. FIGS. 5 to 7 are cross-sectional views of a mold 20 for manufacturing the connector housing 40. FIG. 5 illustrates a state where the mold is opened. The mold 20 is divided into a first mold part 21 and a second mold part 22. Although the second mold part 22 is movable with respect to the first mold part 21, an actuator that moves the second mold part 22 is not illustrated. FIG. 5 illustrates the state where the mold 20 (the first mold part 21 and the second mold part 22) is opened, and FIG. 6 illustrates a state where the mold 20 is closed. The first mold part 21 corresponds to the tip end portion 41 of the connector housing 40, and the second mold part 22 corresponds to the rear portion 32 of the connector housing 40. When the mold 20 is closed, an internal space (a cavity Ca) that has the same shape as the connector housing 40 is formed (see FIG. 6). FIG. 5 illustrates a shape of the connector housing 40 with an imaginary line.

The first mold part 21 includes a first projection 211 projecting toward the cavity Ca. The first projection 211 is a portion that forms the inlet 44 of the connector housing 40. A base portion 211a of the first projection 211 tapers off to correspond to the tapering portion 44b of the inlet 44. A tip end portion 211b of the first projection 211 has a straight cylindrical shape to correspond to the parallel hole portion 44a of the inlet 44. A diameter of the tip end portion 211b is equal to the diameter D1 of the parallel hole portion 44a.

The second mold part 22 includes a second projection 221 projecting toward the cavity Ca. The second projection 221 is a portion that forms the connection space 45 of the connector housing 40. A diameter of the second projection 221 is equal to the diameter D2 of the connection space 45 and is larger than the diameter D1 of the tip end portion 211b of the first projection 211. The second projection 221 is arranged with an end face thereof facing an end face of the first projection 211. An end face 222 of the second projection 221 is provided with a recess 223.

When the second mold part 22 approaches the first mold part 21 and the mold 20 is closed, an end (tip end) of the first projection 211 fits into the recess 223 provided at the end (tip end) of the second projection 221, as illustrated in FIG. 6. The cavity Ca is then formed inside the closed mold 20. A boundary between a side surface of the first projection 211 and the recess 223 (or the end face 222) of the second projection 221 corresponds to the parting boundary (the parting line).

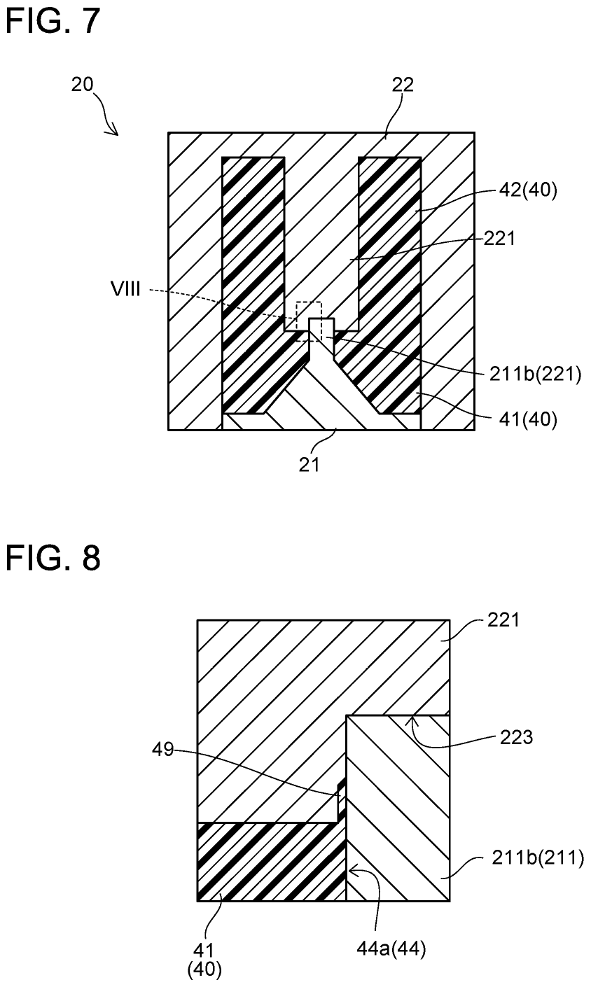

The manufacturing method for the connector housing 40 includes a process of injecting molten resin into the cavity Ca of the mold 20. FIG. 7 illustrates a state where the molten resin has been injected into the cavity Ca. A range of the cavity Ca in FIG. 6 is replaced with the connector housing 40.

FIG. 8 is an enlarged view of a range VIII in FIG. 7. FIG. 8 is an enlarged view of a portion where the tip end portion 211b of the first projection 211 is fitted in the recess 223 of the second projection 221. In other words, FIG. 8 is an enlarged view of a portion around the parting boundary (the parting line) of the mold 20. A part of the molten resin enters the boundary between the side surface of the first projection 211 and the recess 223 to form the burr 49. The burr 49 grows along a side surface of the tip end portion 211b that corresponds to the parallel hole portion 44a (see FIGS. 3 and 4). That is, a growth direction of the burr 49 is coincident with the inserting direction of the control terminal 13. Therefore, as described referring to FIG. 4, even if the burr 49 remains in the finished connector housing 40, the burr 49 does not damage the control terminal 13 because it extends along the inserting direction of the control terminal 13.

As described above, according to the manufacturing method for a connector housing disclosed herein, the extending direction of the burr 49 formed at the inlet 44 for the control terminal 13 is coincident with the inserting direction of the control terminal 13. Thus, even if the burr remains, damage on the control terminal 13 is prevented.

Some features related to the technique described herein will be described. The control terminal 13 is constituted of metal and is an example of a metal terminal. In the mold 20, the second mold part 22 including the second projection 221 is moved with respect to the first mold part 21. The first mold part 21 may be moved with respect to the second mold part 22. That is, it may be sufficient that the first mold part 21 and the second mold part 22 are configured to be movable relative to each other.

Specific examples of the present disclosure have been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A manufacturing method for a connector housing to which an elongated metal terminal is connected, the manufacturing method comprising:
injecting molten resin into a mold so as to form the connector housing,
wherein
the mold comprises:
a first projection configured to form an inlet for the metal terminal; and
a second projection configured to form a terminal connection space communicating with the inlet, the second projection being movable relative to the first projection,
a diameter of a tip end of the second projection is larger than a diameter of a tip end of the first projection, and
a recess in which the tip end of the first projection is inserted is provided in an end face of the second projection.

2. The manufacturing method as in claim 1, wherein the first projection tapers off to the end.
